(19) United States
(12) Patent Application Publication
(10) Pub. No.: US 2020/0130214 A1
(43) Pub. Date: Apr. 30, 2020

(54) APPARATUS FOR CUTTING TYRES

(71) Applicant: TYRE RECYCLING SOLUTIONS SA, Lully (CH)

(72) Inventor: Staffan AHLGREN, Lully (CH)

(21) Appl. No.: 16/083,515

(22) PCT Filed: Mar. 10, 2017
(86) PCT No.: PCT/IB2017/051411

§ 371 Date: Sep. 10, 2018

(30) Foreign Application Priority Data
Mar. 10, 2016 (CH) 00310/16

(51) Int. Cl. B26D 3/00; B26D 1/10; B26D 1/18; B26D 7/02

(52) U.S. Cl. CPC B26D 3/005; B26D 7/02; B26D 1/18; B26D 1/10

(57) ABSTRACT

An apparatus for cutting tires comprises a frame (1), an accommodation zone (2) intended to receive a tire (31) to be cut, lateral holding means (5, 6) for a tire, a detector (4) capable of detecting a central zone of a tire (31), blades (7) mounted to slide between a separated position of disengagement of the tread and a working position in which they penetrate into the sidewall (32) of a tire, and a control (9) ensuring that the blades (7) penetrate into the side walls (32) of the tire (31) only when they are above its tread (33). The lateral holding means (5, 6) comprise a vertically sliding jaw (6) capable of pressing against the bead (34) of a tire (31) and a part (5) with two branches (37) each bearing a wheel (38) capable of coming into contact with an inner surface (35) of the tread (33) of a tire, the jaw (6) and the part (5) being diametrically opposed relative to the inner circumference of a tire. The blades (7), when they are in working position, penetrate into the side walls (32) of a tire (31) received between the two branches (37) so as to stabilize the cutting zone.

The present invention relates to a tire cutting apparatus. In particular, the present invention consists of an apparatus for cutting tires of the type comprising a tread, side walls and beads so as to cut the side walls and cut off the tread in order to reduce the bulk of a worn tire and facilitate the subsequent recovery of its components, but also the storage and transportation.

In fact, by virtue of their shape and their configuration, the worn tires of vehicles do not make it possible to optimize their storage and their transportation. The high amount of empty space of a tire means a loss of useful transportation and storage space.

The state of the art discloses apparatuses ensuring the cutting of the side walls and the cutting off of the tread of a tire. Thus, WO2012059719 for example is known which describes a piece of equipment for processing a vehicle tire by cutting the tire into portions. The piece of equipment comprises a rotary tire support that can be operated to removably retain a tire, a motor arrangement that can be operated to rotate the tire support, a first cutting arrangement that can be operated, in service, to separate the sidewall parts of a tire from the tread part and a second cutting arrangement that can be operated to cut the tread part of the tire to make a strip thereof.

The drawback of this embodiment is that the tire is held by its side walls and that the cutting of the side walls which is done on either side of the tread is not always uniform and of good quality.

The object of the invention is to remedy this drawback by proposing an apparatus which cuts the side walls uniformly.

According to the invention, an apparatus for cutting tires of the type comprising a tread, side walls and beads so as to cut the side walls and cut off the tread, comprises a frame, an accommodation zone intended to receive a tire to be cut in the frame, the accommodation zone comprising a pair of drive rollers which cooperate in particular with the tread of a tire placed on the drive rollers in the accommodation zone. The apparatus also comprises two support structures mounted above and on either side of the accommodation zone, lateral holding means for a tire, the lateral holding means being mounted on at least one of the two support structures, a detector, in particular an optical detector capable of detecting a central zone of a tire received in the accommodation zone lying between the inner diameter of the beads of the tire, the detector being arranged on at least one of the two support structures. The apparatus also comprises blades mounted on the support structures and arranged transversely, oriented toward a sidewall of a tire received in the accommodation zone, said blades being mounted to slide between a separated position of disengagement of the tread and a working position in which they penetrate into the sidewall of a tire. A device for cutting a tread of a tire received in the apparatus, when said tread is separated from its side walls, is arranged on the frame, sliding to cut the tread transversely. A control governs the sequencing of the steps and in particular the rotation of at least one roller of the pair of rollers and a time-delayed sliding of said blades between a separated position and a working position in order for the blades to penetrate into the side walls of the tire received in the apparatus only when they are above its tread. The lateral holding means comprise a vertically sliding jaw capable of pressing against the bead of a tire received in the apparatus and a part with two branches each bearing at least one wheel coming into contact with an inner surface of the tread of a tire received in the apparatus. The jaw and said part are diametrically opposed relative to the inner circumference of a tire received in the apparatus, and the blades, when they are in working position, penetrate into the side walls of a tire received, in proximity to the two branches of the holding part or between the two branches of the holding part so as to stabilize the cutting zone.

In one embodiment, the cutting device for the tread of a tire to be cut, when said tread is separated from its side walls, comprises a top arm and a bottom arm, the top or bottom arm bearing, at one of its ends, a pair of coaxial disks spaced apart from one another. The other top or bottom arm bears an essentially circular blade arranged between the disks. The cutting device slides to transversely cut the tread of a tire to be cut when said tread is separated from its side walls.

In one embodiment, the essentially circular blade is completely circular and preferably knurled on the edge when it is beveled.

In a variant, the essentially circular blade comprises several radii of curvature.

Preferably, the essentially circular blade is beveled.

In one embodiment, the top arm and the bottom arm have an elongate form whose length is at least equal to the width of the tread of a tire to be cut.

In a preferential embodiment, the control consists of a single logic controller governing all the functions of the apparatus.

In one embodiment, the accommodation zone comprises blocking elements on either side of a tire received in the apparatus and are arranged so as to slide horizontally to approach one another and pinch a tire received in the apparatus.

According to this same embodiment, the blocking elements are cylinders, free to rotate about their longitudinal axis, entering into contact with the side walls of a tire to be cut so as to rotate synchronously with the tire when it is driven by at least one of the rollers of the pair of drive rollers.

Preferably, the apparatus comprises a shroud for at least partially enclosing the apparatus with, as appropriate, a tire to be cut inside the apparatus, and at least one sensor for detecting the opening of the shroud and stopping a cutting cycle.

In one embodiment, the detector capable of detecting a central zone of the tire emits a laser beam.

Preferably, the lateral holding means for a tire received in the apparatus make it possible to lock in position tires of which the inner diameter of the beads varies from 30 centimeters to 60 centimeters.

In one embodiment, the apparatus comprises a sensor for detecting the presence of a tire to be cut on the accommodation zone.

In one embodiment, the cutting device arranged on the frame comprises means for grabbing a tread arranged to clasp the tread during the transverse cutting of the tread.

The invention relates also to a method for cutting a tire using the above apparatus.

The features of the invention will emerge more clearly on reading the description given purely as a nonlimiting example with reference to the schematic figures, in which:

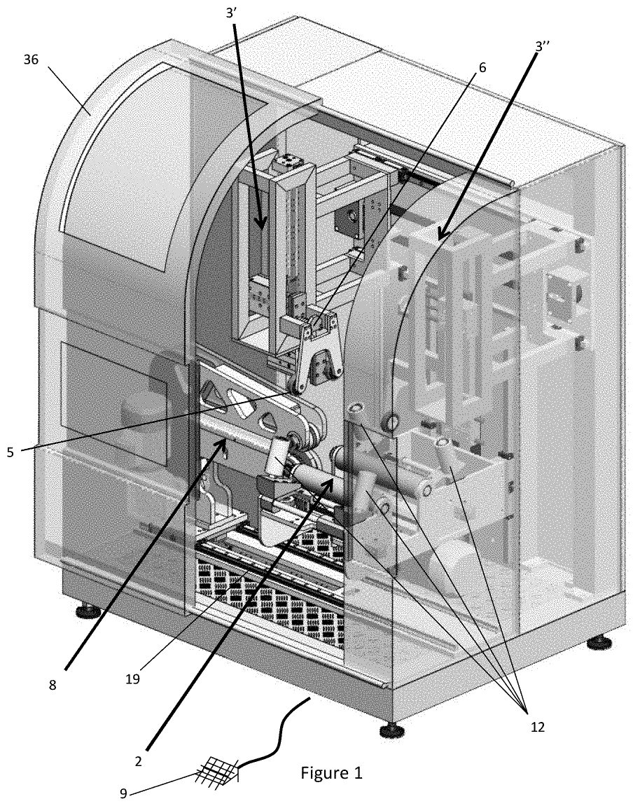

FIG. 1 represents a transparent perspective view of a tire cutting apparatus, a protective shroud of the apparatus being open;

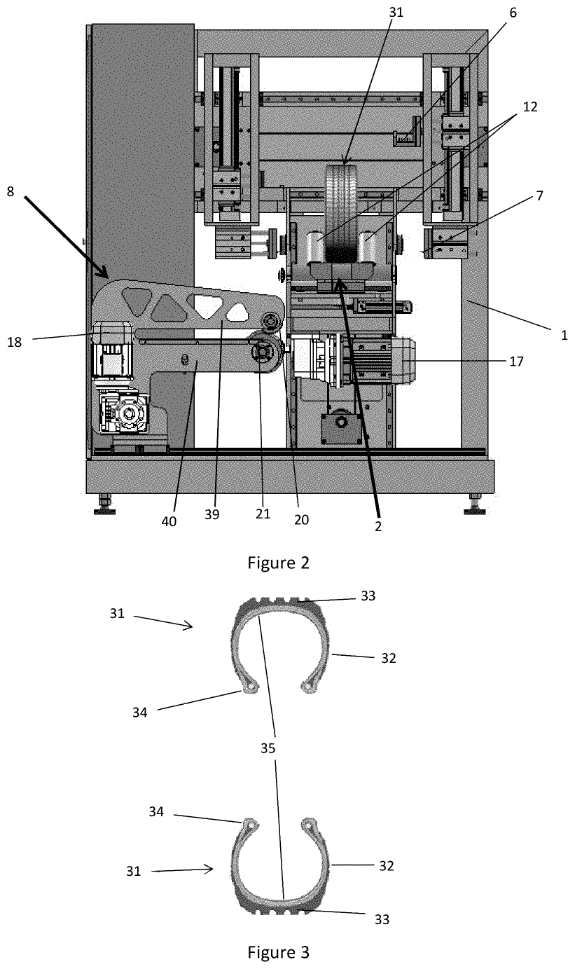

FIG. 2 represents a front view of the tire cutting apparatus, without its protective shroud, including a tire ready to be cut;

FIG. 3 represents a cross-sectional view of a tire;

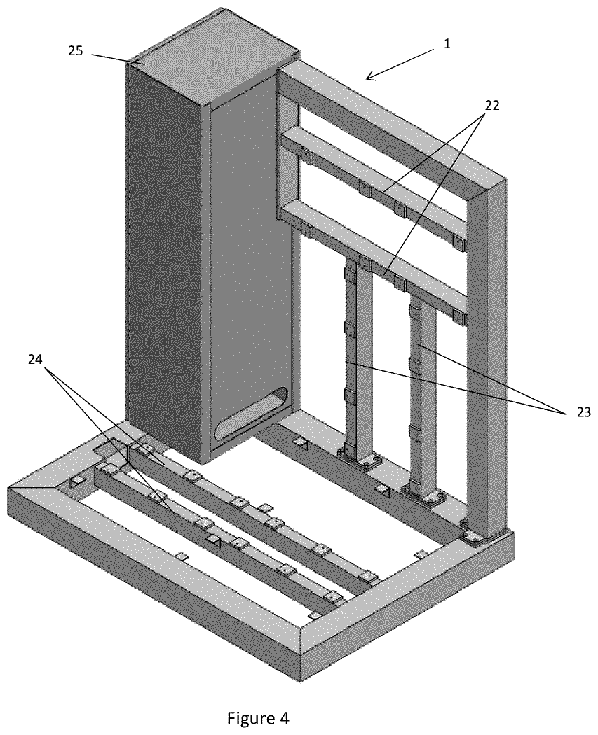

FIG. 4 represents a perspective view of a frame of the apparatus;

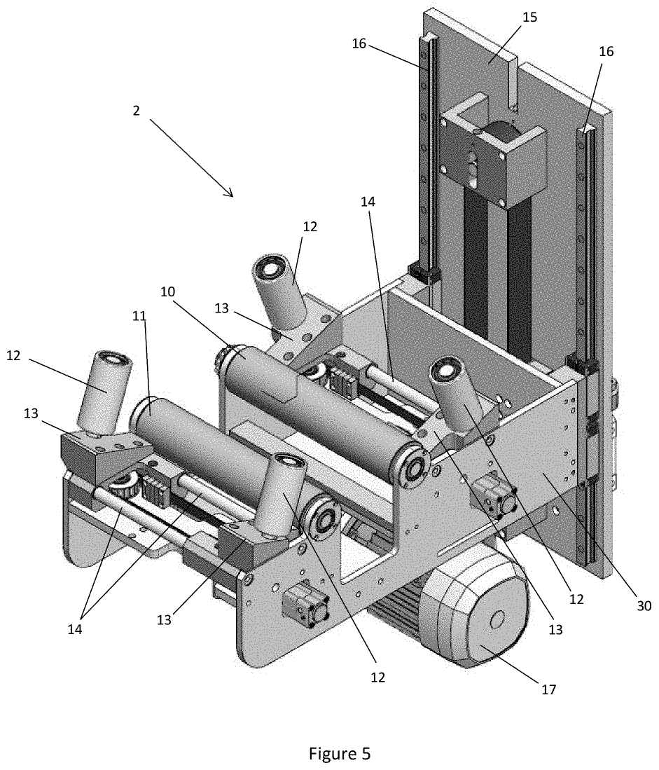

FIG. 5 represents a perspective view of an accommodation zone arranged to receive a tire;

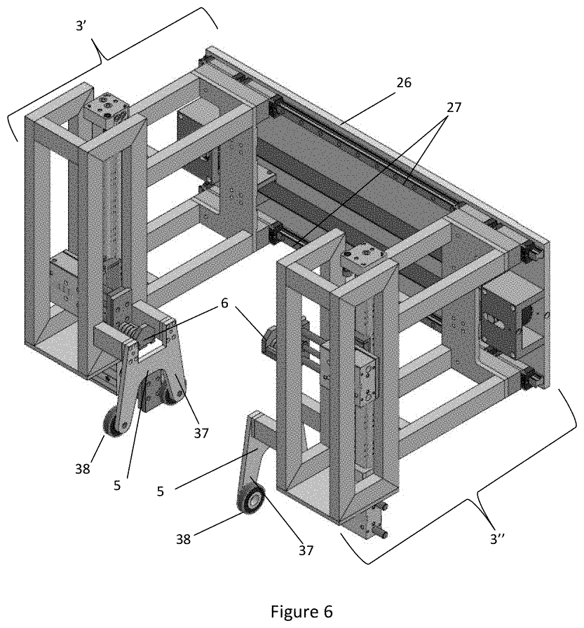

FIG. 6 represents a perspective view of the lateral holding means for the tire during cutting;

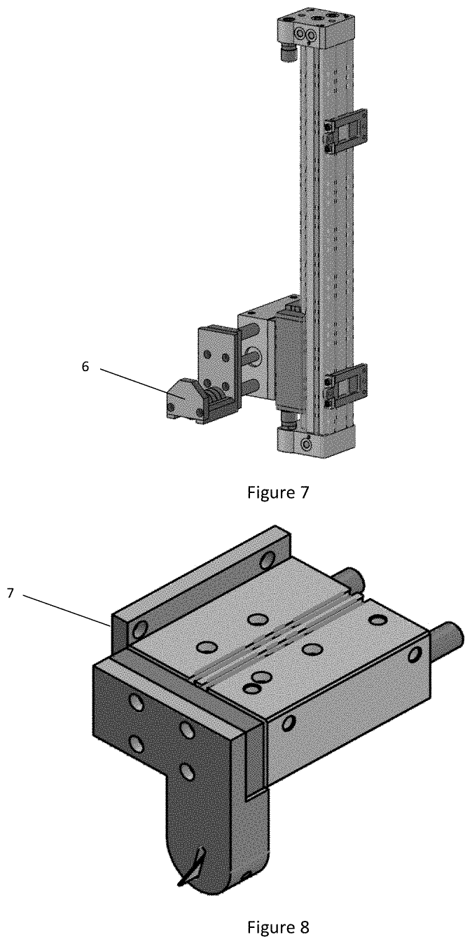

FIG. 7 represents a perspective view of a means of holding the bead of the tire;

FIG. 8 represents a perspective view of a device for cutting the side walls of the tires;

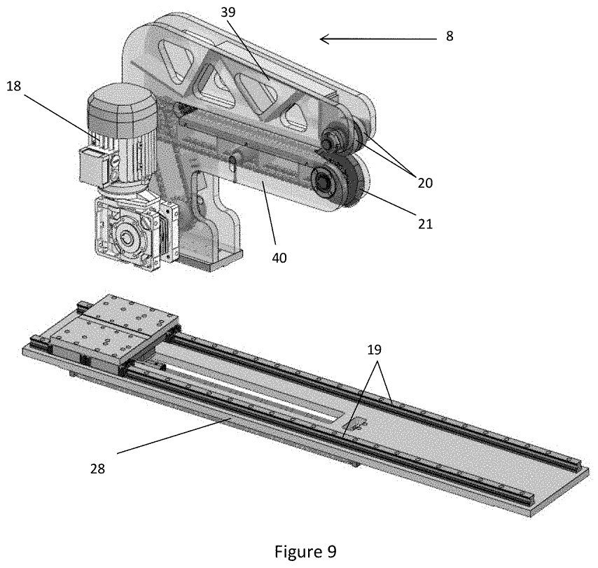

FIG. 9 represents a perspective view of a means for cutting a tread of the tire and a support plate on which the cutting means slides;

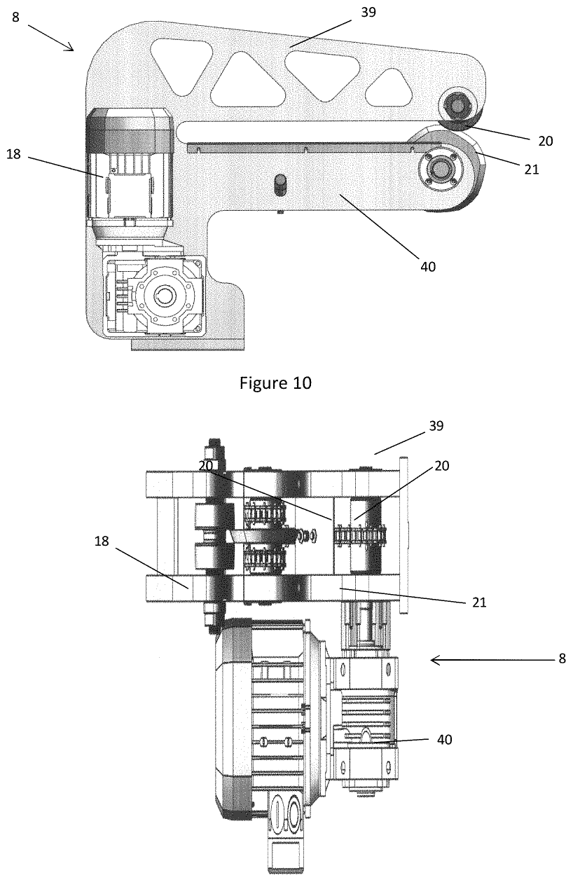

FIG. 10 represents a side view of the means for cutting a tread of the tire;

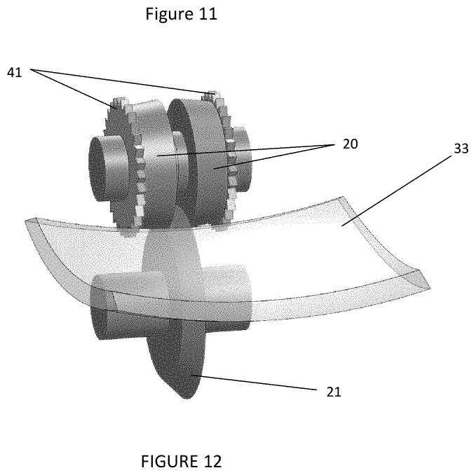

FIG. 11 represents a front view of the means for cutting a tread of the tire; and

FIG. 12 represents a partial view of the cutting means according to another embodiment.

As illustrated in FIG. 1, an assembled tire cutting apparatus comprises an open sliding protective shroud 36, making it possible to see all of the elements that make it possible to cut the tires. In this example, the pedal 9 makes it possible to launch a cutting cycle.

As illustrated in FIG. 2, the apparatus is mounted without its protective shroud 36. The apparatus comprises a frame 1 surrounding an accommodation zone 2 receiving a tire 31 ready to be cut. The apparatus as illustrated is not in a normal operating phase because the tire 31 is not held by the lateral holding means 5, 6 (FIG. 6). The tire 31 is placed between cylindrical rollers 12 free to rotate about their longitudinal axis. The accommodation zone 2 slides vertically and is in high position for a future cutting operation whereas, upon the loading of the tire 31 in the accommodation zone 2, the latter is in low position to facilitate the handling operation performed by an operator to arrange the tires 31 to be cut in the accommodation zone. A cutting device 8 for a tread of the tire 31, when the tread is separated from its side walls, is arranged, on the frame 1, sliding, to cut the tread transversely.

As illustrated in FIG. 3, the cross-sectional view of the tire 31 makes it possible to see the four parts of the tire 31, namely the side walls 32, the tread 33, the bead 34, and the interior 35 of the tread.

As illustrated in FIG. 4, the frame 1 is composed of a box 25 in which can be incorporated all the electrical part, the adjustment block or even a supervisory tool. The frame 1 also comprises two first horizontal bars 22 situated on the high part of the frame 1 allowing in particular the fixing of two support structures 3′, 3″ mounted above and on either side of the accommodation zone 2 (FIGS. 5 and 6). Two vertical bars 23 situated below the two first horizontal bars 22 allowing the fixing of the accommodation zone 2 (FIG. 5). Finally, two second horizontal bars 24 allowing the fixing of the cutting device 8 (FIG. 9).

As illustrated in FIG. 5, the accommodation zone 2 intended to receive a tire to be cut in the frame, comprises a pair of horizontal drive rollers 10, 11 for a tire received in the accommodation zone 2 is placed on the rollers 10, 11. The accommodation zone 2 is composed of a mounting 30 making it possible to fix a first motor 17 which rotationally drives one of the two rollers 10, 11 thus driving the tire to be cut. Four boots 13 onto which are respectively fixed a cylinder 12 that is free to rotate about its longitudinal axis, making it possible to pinch the side walls of the tires to be cut. These boots 13 are fixed to a first guiding rail 14 thus making it possible to adjust the holding of the tire according to the size of said tire. The mounting 30 is fixed, for its part, to two second vertical guiding rails 16 thus making it possible to vertically set the height of the accommodation zone 2 along a support plate 15 which, for its part, is fixed to the two vertical bars of the frame.

As illustrated in FIG. 6, the tire cutting apparatus comprises two support structures 3′, 3″ mounted above and on either side of the accommodation zone. The two support structures 3′, 3″ are borne by a second support plate 26, fixed onto the two first horizontal bars 22 situated on the high part of the frame 1 (FIG. 4). This second support plate 26 bears two fourth guiding rails 27 making it possible to horizontally displace the two support structures 3′, 3″. This horizontal displacement is triggered by information given by a laser ray emitted by a device borne by the support structure 3′, 3″. This laser ray is parallel to the tread of a tire to be cut. The two support structures 3′, 3″ bear lateral holding means 5, 6 composed on the one hand of a part 5 comprising two branches 37 and two wheels 38 making it possible to hold the interior of the tread 35 of the tire to be cut (FIG. 3), and, on the other hand, a jaw 6 making it possible to hold the bead of the tire to be cut. The jaw 6 (FIG. 7) slides vertically along the support structures 3′, 3″ in order to hold the bead of the tire to be cut according to the size thereof. The jaw 6 and the part 5 are diametrically opposed relative to the inner circumference of a tire received in the apparatus. The jaws 6 and the part 5 make it possible to lock in position tires 31 to be cut of which the inner diameter of the beads varies from 30 centimeters to 60 centimeters. The blades 7 (FIG. 8), arranged on each support structure 3′, 3″, when they are in working position, penetrate into the side walls of a tire received between the two branches 37 so as to stabilize the cutting zone. In this example, the blades 7 are arranged between the two branches 37 of the part 5.

One advantage of the use of the jaws 6 and the part 5 is that the apparatus adapts to the dimensions of the tires that have to be cut, both on the inner diameter of the beads and on the thickness of tread which varies from one tire to the other and can be between 6 and 35 millimeters. Indeed, the part 5, comprising two branches 37 and two wheels 38 allowing the holding of the interior of the tread, makes it possible to accurately determine the position of the tread of the tire to be cut and thus avoid having the blade 7 pressed into the tread.

As illustrated in FIG. 7, the jaw 6 is fixed onto each support structure thus making it possible to slide vertically along each support structure 3′, 3″ in order to hold the bead of the tire to be cut.

In the example illustrated in FIGS. 9, 10 and 11, the cutting device 8 for the tread of a tire to be cut, when said tread is separated from its side walls, is composed of two arms 39, 40. The cutting means 8 is arranged on a third support plate 28 composed, for its part, of two third horizontal rails 19 so as to be able to be displaced horizontally along the two third rails 19. The top arm 39 bears, at one of its ends, a pair of coaxial disks 20 spaced apart from one another, the other, bottom arm 40, bearing an essentially circular blade 21 arranged between the disks 20. The cutting device 8 slides to transversely cut the tread when said tread is separated from its side walls. A second motor 18 rotationally drives the blade of circular form 21 thus making it possible to cut the tread once the side walls of the tire have been cut in the first cutting phase. In this example, the essentially circular blade 21 comprises several radii of curvature and is beveled.

Advantageously, the apparatus is arranged in such a way that each blade 7, 21 is lubricated at defined intervals to enhance the cutting.

In an embodiment illustrated in FIG. 12, to clasp the tread against the edge thereof, grabbing means have been incorporated in the cutting device 8 (FIG. 10). In this example, the pair of coaxial disks 20 spaced apart from one another and borne by the top arm 39 (FIG. 10) comprises clasping means 41, here toothed wheels 41 arranged on either side of the pair of disks 20. In this example, the tread 33 is pushed mechanically in the cutting direction against the cutting disk 21 from the pair of disks 20, which is itself rotated. Contrary to the preceding example in which the pair of shearing disks is not driven, this time, the pair of shearing disks 20 is rotated synchronously with the cutting blade 21. The two toothed wheels 41 arranged on either side of the disks 20 are secured with said disks 20 so that, when the teeth of the rotated toothed wheels 41 strike the tread, the teeth create a driving of the tread towards the cutting disk 21, in the cutting direction. After having opened the protective shroud 36, the operator places the tire 31 in the accommodation zone 2 on the two rollers 10, 11 and between the four cylinders 12. The tread of the tire to be cut comes into contact with two rollers 10, 11. At this stage, the accommodation zone 2 is in low position so as to facilitate handling. The operator then closes the protective shroud 36 and presses on the pedal 9, or any other control such as a pushbutton, to launch a cutting cycle. The cutting cycle comprises the following steps:
verification of the presence of a tire by a sensor,
pinching of the tire between the cylinders 12,
raising of the accommodation zone 2 including the tire by a vertical displacement until the central zone, between beads, of the tire to be cut is detected by the laser beam,
convergence of the support structures 3′, 3″ by horizontal sliding to hold beads of the tire by the jaws 6 and the interior of the tread by the part 5 and its two branches 37,
pressing onto the internal part 35 of the tread 33 by the part 5 with two branches, then,
pressing onto the beads 34 by the jaws 6,
rotation of the tire 31 by at least one of the rollers of the pair of drive rollers 10, 11,
cutting of the side walls 32 of the tire by the blade 7 arranged on each support structure 3′, 3″,
optionally, separation of the two support structures 3′, 3″ of which each jaw 6 bears a cut side wall,
lowering of the accommodation zone 2 including the tread without its side walls until the tread is facing the cutting device 8,
transverse cutting of the tread 33 by horizontal sliding of the cutting device 8, then return of the cutting device 8 to its initial position,
opening of the protective shroud 36 by the user for recovery of the cut-off tread on the two rollers 10, 11 and of the side walls on each of the jaws 6.

The apparatus preferably comprises, under the frame 1, a receptacle for recovery of the waters and other liquids that can accumulate in the tires during their storage and which escapes during a cutting operation.

The displacements which are described above as being vertical, can also be horizontal and vice-versa or inclined.

The apparatus according to the present invention makes it possible to cut the side walls of tires with accurate and uniform cutting, to cut off the tread and to minimize the handling operations for better productivity.

1. An apparatus for cutting tires of the type comprising a tread, side walls, and beads, so as to cut the side walls, the apparatus comprising:
a frame (1),
an accommodation zone (2) intended to receive a tire (31) to be cut in the frame (1), said accommodation zone (2) comprising a pair of drive rollers (10, 11) for a tire placed on the drive rollers (10, 11) in the accommodation zone (2),
two support structures (3′, 3″) mounted above and on either side of the accommodation zone (2),
lateral holding means (5, 6) for a tire received in the accommodation zone, said holding means being mounted on at least one of the two support structures (3′, 3″),
a detector, in particular an optical detector (4), capable of detecting a void central zone of a tire (31) received in the accommodation zone (2), lying between the inner diameter of the beads (34) of the tire (31), said detector (4) being arranged on at least one of the two support structures (3′, 3″),
blades (7) mounted on the support structures (3′, 3″) and arranged transversely, oriented toward a sidewall (32) of a tire (31) received in the accommodation zone (2), said blades (7) being mounted to slide between a separated position of disengagement of the tread (33) and a working position in which they penetrate into the sidewall (32) of a tire in order to separate the tread from its side walls, and
a controlling logic control (9) governing the rotation of at least one roller of the pair of rollers (10, 11), and the sliding of said blades (7) between a separated position and a working position in order for the blades (7) to penetrate into the side walls (32) of a tire (31) received in the apparatus only when they are above its tread (33),
in which the lateral holding means (5, 6) comprise:
a sliding jaw (6) capable of pressing against the bead (34) of a tire (31) received in the apparatus, and
a part (5) with two branches (37) each bearing a wheel (38) arranged to be inserted into a tire received in the apparatus and whose two branches are capable of coming into contact with an inner surface (35) of the tread (33) of the tire,
the jaw (6) and the part (5) are diametrically opposed relative to the inner circumference of a tire received in the apparatus, and
the blades (7), when they are in working position, penetrate into the side walls (32) of a tire (31) when the blades are in proximity to or received between the two branches (37) so as to stabilize the cutting zone.

2. The apparatus as claimed in claim 1, comprising a cutting device (8) arranged on the frame (1), said cutting device (8) sliding to cut the tread (33) transversely.

3. The apparatus as claimed in claim 2, in which the cutting device (8) for the tread (33), when said tread (33) is separated from its side walls (32), comprises a top arm (39) and a bottom arm (40), the top (39) or bottom (40) arm bearing, at one of its ends, a pair of coaxial disks (20) spaced apart from one another, the other top (39) or bottom (40) arm bearing an essentially circular blade (21) arranged between said disks (20), said cutting device (8) sliding to transversely cut the tread (33) when said tread (33) is separated from its side walls (32).

4. The apparatus as claimed in claim 3, in which the essentially circular blade (21) comprises several radii of curvature.

5. The apparatus as claimed in claim 3, in which the essentially circular blade (21) is beveled.

6. The apparatus as claimed in claim 3, in which the top arm (39) and the bottom arm (40) have an elongate form whose length is at least equal to the width of the tread (33) of a tire (31) to be cut.

7. The apparatus as claimed in claim 1, characterized in that the control (9) consists of a single logic controller governing all the functions of the apparatus.

8. The apparatus as claimed in claim 1, in which the accommodation zone (2) comprises blocking elements (12) on either side of a tire (31) received in the apparatus and are arranged so as to slide horizontally to approach one another and pinch a tire (31) received in the apparatus.

9. The apparatus as claimed in claim 8, in which the blocking elements (12) are cylinders, free to rotate about their longitudinal axis, entering into contact with the side walls (32) of a tire (31) to be cut so as to rotate synchronously with the tire (31) when it is driven by at least one roller of the pair of drive rollers (10, 11).

10. The apparatus as claimed in claim 1, comprising a shroud (36) for at least partially enclosing the apparatus with, as appropriate, a tire (31) to be cut inside the apparatus, and at least one sensor for detecting the opening of the shroud (36) and stopping a cutting cycle.

11. The apparatus as claimed in claim 1, in which the detector (4) capable of detecting a central zone of the tire (31), emits a laser beam.

12. The apparatus as claimed in claim 1, in which the lateral holding means (5, 6) for a tire (31) received in the apparatus make it possible to lock in position tires (8) of which the inner diameter of the beads (34) varies from 30 centimeters to 60 centimeters.

13. The apparatus as claimed in claim 1, comprising a sensor for detecting the presence of a tire (31) on the accommodation zone (2).

14. The apparatus as claimed in claim 2, in which the cutting device (8) arranged on the frame (1) comprises means for grabbing a tread (33) arranged to clasp the tread during the transverse cutting of the tread (33).

15. A method for cutting a tire as claimed in claim 1 comprising the following steps:
verification of the presence of a tire (31) by a sensor,
pinching of the tire between the cylinders (12),
raising of the accommodation zone (2) including the tire by a vertical displacement until the central zone, between beads, of the tire to be cut is detected by the laser beam,
convergence of the support structures (3′, 3″) by horizontal sliding to hold beads of the tire by the jaws (6) and the interior of the tread (33) by the part (5) and its two branches (37),
pressing on the inner part (35) of the tread by the part (5) with two branches, then,
pressing on the beads (34) by the jaws (6),
rotation of the tire by at least one of the rollers of the pair of drive rollers (10, 11),
cutting of the side walls (32) of the tire by the blade (7) arranged on each support structure (3′, 3″),
optionally, separation of the two support structures (3′, 3″) of which each jaw (6) bears a cut side wall,
lowering of the accommodation zone (2) including the tread without its side walls until the tread is facing the cutting device (8),
transverse cutting of the tread (33) by horizontal sliding of the cutting device (8), then return of the cutting device (8) to its initial position,
opening of the protective shroud (36) by the user for recovery of the cut-off tread on the two rollers (10, 11) and of the side walls on each of the jaws (6).
